(19) United States
(12) Patent Application Publication
(10) Pub. No.: US 2019/0094745 A1
(43) Pub. Date: Mar. 28, 2019

(54) INFORMATION PROCESSING APPARATUS AND IMAGE FORMING APPARATUS

(71) Applicant: CANON KABUSHIKI KAISHA, Tokyo (JP)

(72) Inventor: Shuichi Nakamura, Tokyo (JP)

(21) Appl. No.: 16/127,946

(22) Filed: Sep. 11, 2018

(30) Foreign Application Priority Data
Sep. 25, 2017 (JP) 2017-183514

(51) Int. Cl. G03G 15/04; H04N 1/32

(52) U.S. Cl. CPC G03G 15/0409; H04N 1/32683; G03G 15/04072

(57) ABSTRACT

In an information processing apparatus connected to an image forming apparatus including an image forming unit, the image forming unit includes a first receptor, a light source, a photosensitive member, a rotary polygon mirror, a light receptor, and a first output unit configured to stops outputting a predetermined signal after the image data for one surface of a recording medium is output, and resumes outputting the predetermined signal in response to the timing when image formation for one surface of a subsequent recording medium is started. The information processing apparatus includes a second receptor, a memory, a determiner configured to, determine a reflection surface based on information stored in the memory, a corrector configured to correct the image data, and a second output unit configured to, in response to start of receiving the predetermined signal, start outputting the image data.

### BACKGROUND

### Field

The present disclosure relates to an information processing apparatus for correcting image data and transmitting the image data to an image forming apparatus, and the image forming apparatus connected with the information processing apparatus.

### Description of the Related Art

A conventional laser electrophotographic image forming apparatus is known to have a configuration in which a laser beam deflected by a rotating polygon mirror scans the outer circumferential surface of a photosensitive drum, and a latent image is formed on the outer circumferential surface of the photosensitive drum.

The surfaces of the polygon mirror for deflecting the laser beam are different in shape. Different shapes of the surfaces cause the distortion of the latent image formed on the outer circumferential surface of the photosensitive drum by the laser beam deflected by respective surfaces.

U.S. Pat. No. 9,575,314 discusses a configuration in which an image controller identifies a surface of a polygon mirror where a laser beam is to be deflected, based on a time interval between adjacent pulses of an input main scanning synchronization signal (this processing is referred to as surface identification). More specifically, the image controller performs processing for measuring the time interval between adjacent pulses and identifying a surface corresponding to each of the pulses based on a measurement result. The image controller performs corrections each corresponding to a different surface (correction of the image drawing start position) with respect to image data. Image formation is performed based on the corrected image data. Surface identification is performed before an image of the first page is formed.

Japanese Patent Application Laid-Open No. 2000-313140 discusses a configuration in which an engine controller and a video controller transmit and receive data through signal lines. In Japanese Patent Application Laid-Open No. 2000-313140, a signal line for transmitting a signal for determining the image drawing start timing from the engine controller to the video controller has been removed. Japanese Patent Application Laid-Open No. 2000-313140 also discusses a configuration in which the image drawing start timing is determined by using a signal line for transmitting the main scanning synchronization signal from the engine controller to the video controller, more specifically, a configuration in which the image drawing start timing for the following surface (following page) of a recording medium is determined by stopping the output of the main scanning synchronization signal for each surface (each page) of the recording medium.

In a configuration discussed in Japanese Patent Application Laid-Open No. 2000-313140, the main scanning synchronization signal is not input to the video controller in a time period since the time when an image of the nth page (n is a positive integer) is formed till the time when an image of the (n+1)th page is formed.

For example, when the configuration in U.S. Pat. No. 9,575,314 is applied to the configuration in Japanese Patent Application Laid-Open No. 2000-313140, there is a time period during which the main scanning synchronization signal is not input to the video controller, and the video controller is unable to identify a reflection surface where a laser beam is to be deflected. To perform suitable image data correction according to each reflection surface, the video controller needs to perform surface identification each time when the input of the main scanning synchronization signal is resumed (i.e., each time processing is completed for one page). Since a predetermined time is required to identify a reflection surface, performing surface identification for each page degrades the productivity of an image forming apparatus.

### SUMMARY

According to various embodiments of the present disclosure, an information processing apparatus connected to an image forming apparatus including an image forming unit, the image forming unit includes a first receptor configured to receive image data, a light source configured to output light based on the image data received by the first receptor, a photosensitive member, a rotary polygon mirror having a plurality of reflection surfaces, configured to rotate to deflect the light output from the light source by using a plurality of the reflection surfaces to scan the photosensitive member, a light receptor configured to receive the light deflected by the rotary polygon mirror, and a first output unit configured to output a predetermined signal upon reception of the light by the light receptor in a time period during which the light based on the image data input to the first receptor is output from the light source, stop outputting the predetermined signal after the image data for one surface of a recording medium is output, and resume outputting the predetermined signal according to at the timing when image formation for one surface of a subsequent recording medium following image formation for the one surface of the recording medium is started, the predetermined signal indicating a time interval since the time when the light receptor receives the light to be deflected by a first reflection surface out of a plurality of the reflection surfaces till the time when the light receptor receives the light to be deflected by a second reflection surface which is on the upstream side of the first reflection surface in the rotational direction of the rotary polygon mirror and adjacent to the first reflection surface, and the information processing apparatus includes a second receptor configured to receive the predetermined signal output from the first output unit, a memory configured to store information about time intervals each corresponding to a different one of the plurality of reflection surfaces, a determiner configured to, in a time period during which the predetermined signal is not input to the second receptor, determine a reflection surface by which the light for scanning the photosensitive member is to be deflected, based on the information stored in the memory, a corrector configured to correct the image data based on the correction data corresponding to the reflection surface determined by the determiner, and a second output unit configured to, in response to start of receiving the predetermined signal from the first output unit, start outputting image data to the image forming unit, the image data having been corrected by the corrector and being for the one surface of the subsequent recording medium.

Further features will become apparent from the following description of exemplary embodiments with reference to the attached drawings.

### BRIEF DESCRIPTION OF THE DRAWINGS

FIG. 1 is a sectional view illustrating an image forming apparatus according to a first exemplary embodiment.

FIG. 2 is a diagram illustrating an example of image data read by a reader.

FIG. 3 is a block diagram illustrating a configuration of a laser scanner unit according to the first exemplary embodiment.

FIGS. 4A and 4B are diagrams illustrating an example of a relation between a Beam Detect (BD) signal generated when a laser beam scans a light receiving surface of a BD sensor and a surface (surface number) where the laser beam is to be deflected.

FIG. 5 is a timing chart illustrating relations between various signals according to the first exemplary embodiment.

FIG. 6 is a flowchart illustrating control performed by an engine control unit according to the first exemplary embodiment.

FIG. 7 is a time chart illustrating a relation between a count of a counter and the BD signal according to the first exemplary embodiment.

FIG. 8 is a flowchart illustrating a method performed by an image control unit to estimate the surface number according to the first exemplary embodiment.

FIG. 9 is a flowchart illustrating a method in which image data is corrected and a method in which corrected image data is output to the engine control unit.

FIG. 10 is a flowchart illustrating a method performed by an image control unit to estimate a surface according to a second exemplary embodiment.

FIG. 11 is a time chart illustrating a relation between a count of a counter and a BD signal according to a third exemplary embodiment.

FIG. 12 is a block diagram illustrating a configuration of a laser scanner unit according to the third exemplary embodiment.

FIG. 13 is a diagram including the flowcharts of FIGS. 13A and 13B illustrating control performed by an engine control unit according to the third exemplary embodiment.

FIG. 14 is a block diagram illustrating a configuration of an image control unit according to a fourth exemplary embodiment.

FIG. 15 is a time chart illustrating a relation between an image forming BD signal, a pseudo BD signal, and a count according to the fourth exemplary embodiment.

### DESCRIPTION OF THE EMBODIMENTS

Exemplary embodiments of the present disclosure will be described below with reference to the accompanying drawings. However, shapes and relative arrangements of elements described in the exemplary embodiments are not limited thereto and are to be modified as required depending on the configuration of an apparatus according to the present disclosure and other various conditions. The scope of the present disclosure is not limited to the exemplary embodiments described below.

### Image Forming Operation

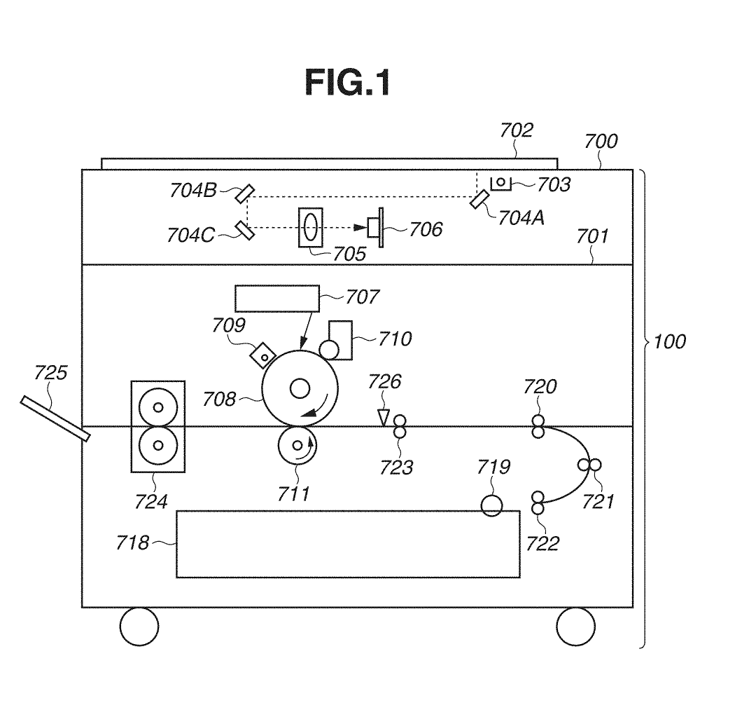

FIG. 1 is a sectional view illustrating the configuration of a monochrome electrophotographic copying machine (hereinafter referred to as an image forming apparatus) 100 according to the first exemplary embodiment. The image forming apparatus is not limited to a copying machine and can be, for example, a facsimile machine, a printing machine, and a printer. The image forming apparatus can be of the monochrome type or the color type.

The configuration and functions of the image forming apparatus 100 will be described below with reference to FIG. 1. As illustrated in FIG. 1, the image forming apparatus 100 includes an image reading apparatus (hereinafter referred to as a reader) 700 and an image printing apparatus 701.

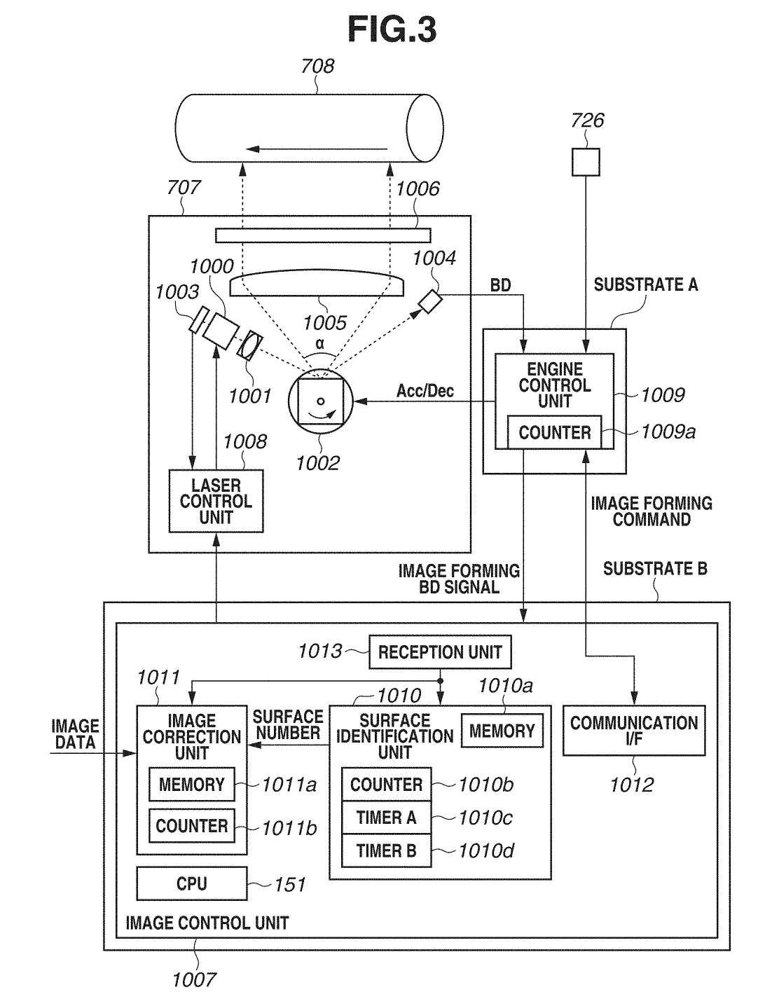

The reflection light from a document irradiated by an illumination lamp 703 at the reading position of the reader 700 is led to a color sensor 706 by an optical system including reflection mirrors 704A, 704B, and 704C and a lens 705. The reader 700 reads light incident to the color sensor 706 for each of three colors, blue (hereinafter referred to as B), green (hereinafter referred to as G) and red (hereinafter referred to as R) and converts the light into electrical image signals. The reader 700 also performs color conversion processing based on the intensity of the B, G, and R image signals to obtain image data and outputs the image data to an image control unit 1007 (described below, refer to FIG. 3).

The image printing apparatus 701 includes a sheet storage tray 718. A recording medium stored in the sheet storage tray 718 is picked up by a feed roller 719 and then conveyed by conveyance roller pairs 722, 721, and 720 to a registration roller pair 723 in a stop state. The leading edge of the recording medium conveyed in the conveyance direction by the conveyance roller pair 720 comes in contact with a nip portion of the registration roller pair 723 in a stop state. When the conveyance roller pair 720 further conveys the recording medium in a state where the leading edge of the recording medium is in contact with the nip portion of the registration roller pair 723 in a stop state, the recording medium bends. As a result, an elastic force acts on the recording medium, and the leading edge of the recording medium evenly contacts the nip portion of the registration roller pair 723. Skew correction for the recording medium is performed in this way. After skew correction for the recording medium is performed, the registration roller pair 723 starts the conveyance of the recording medium at a timing which is described below. Example recording media include paper, resin sheets, cloths, overhead projector (OHP) sheets, labels, and other media on which an image is formed by an image forming apparatus.

The image data obtained by the reader 700 is corrected by the image control unit 1007 and then input to a laser scanner unit 707 including a laser unit and a polygon mirror. The outer circumferential surface of a photosensitive drum 708 is charged by a charging unit 709. After the outer circumferential surface of the photosensitive drum 708 is charged, the laser scanner unit 707 irradiates the outer circumferential surface of the photosensitive drum 708 with a laser beam corresponding to the image data input to the laser scanner unit 707. As a result, an electrostatic latent image is formed on the photosensitive layer (photosensitive member) which covers the outer circumferential surface of the photosensitive drum 708. A configuration in which an electrostatic latent image is formed on the photosensitive layer by a laser beam will be described below.

Subsequently, the electrostatic latent image is developed with toner in a developing unit 710, and a toner image is formed on the outer circumferential surface of the photosensitive drum 708. The toner image formed on the photosensitive drum 708 is transferred to the recording medium by a transfer charger 711 provided at the position (transfer position) facing the photosensitive drum 708. The registration roller pair 723 conveys the recording medium to the transfer position in synchronization with the timing when the toner image is transferred to a predetermined position of the recording medium.

As described above, the recording medium with the toner image transferred thereon is conveyed to a fixing unit 724 in which the recording medium is heated and pressurized so that the toner image is fixed thereto. The recording medium with the toner image fixed thereto is discharged to a discharge tray 725 disposed out of the apparatus.

The image forming apparatus 100 forms an image on the recording medium in this way. This completes descriptions of the configuration and functions of the image forming apparatus 100.

### Configuration of Electrostatic Latent Image Formation

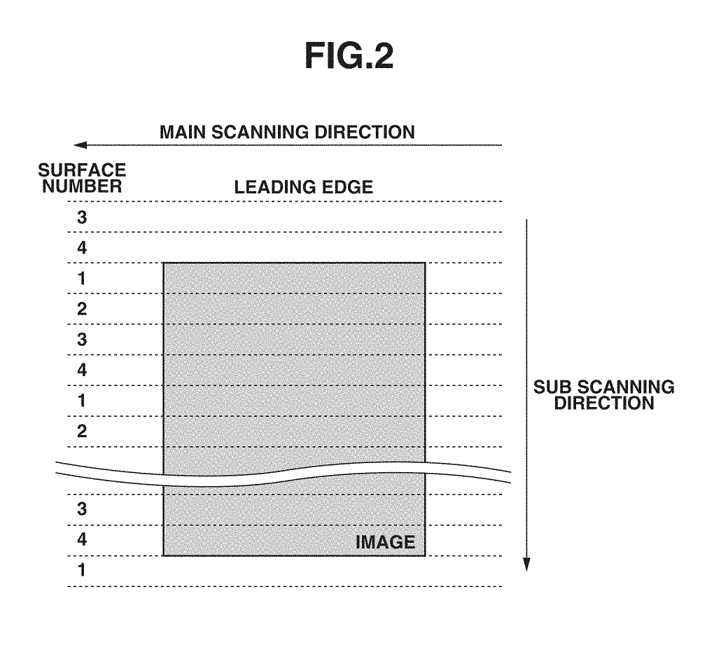

FIG. 2 illustrates an image for one surface of a recording medium. Each surface number illustrated in FIG. 2 indicates a different one of reflection surfaces of a polygon mirror 1002. According to the present exemplary embodiment, the polygon mirror 1002 has four reflection surfaces.

As illustrated in FIG. 2, when a laser beam deflected by one of a plurality of the reflection surfaces of the polygon mirror 1002 scans the photosensitive layer in the axial direction (main scanning direction) of the photosensitive drum 708, an image (electrostatic latent image) for one scan (one line) is formed on the photosensitive layer. When a laser beam deflected by respective surfaces repetitively scans the photosensitive layer in the rotational direction (sub scanning direction) of the photosensitive drum 708, an electrostatic latent image for one surface of the recording medium is formed on the photosensitive layer.

In the following descriptions, data of an image corresponding to an electrostatic latent image for one line is referred to as image data.

### Laser Scanner Unit

FIG. 3 is a block diagram illustrating a configuration of the laser scanner unit 707. The configuration of the laser scanner unit 707 will be described below. According to the present exemplary embodiment, as illustrated in FIG. 3, a substrate A with an engine control unit 1009 provided thereon is a different from a substrate B with the image control unit 1007 provided thereon. The substrate A with the engine control unit 1009 provided thereon is connected with the substrate B with the image control unit 1007 provided thereon via a cable. The image control unit 1007 and the engine control unit 1009 are controlled by a central processing unit (CPU) 151.

As illustrated in FIG. 3, a laser beam is emitted from both end portions of a laser beam source 1000. A laser beam emitted from one end portion of the laser beam source 1000 enters a photodiode (PD) 1003. The PD 1003 converts the incident laser beam into an electrical signal and outputs the electrical signal to a laser control unit 1008 as a PD signal. Based on the input PD signal, the laser control unit 1008 controls the output light amount of the laser beam source 1000 so that the output light amount of the laser beam source 1000 becomes a predetermined light amount (hereinafter this control is referred to as Auto Power Control (APC)).

Meanwhile, the laser beam emitted from the other end portion of the laser beam source 1000 is radiated onto the polygon mirror 1002 as a rotary polygon mirror via a collimator lens 1001.

The polygon mirror 1002 is driven to rotate counterclockwise by a polygon motor (not illustrated). The polygon motor is controlled by a drive signal (Acc/Dec) output from the engine control unit 1009. Although, in the present exemplary embodiment, the polygon mirror 1002 rotates counterclockwise, the polygon mirror 1002 may be configured to rotate clockwise.

The laser beam radiated onto the rotating polygon mirror 1002 is deflected by the polygon mirror 1002. The laser beam deflected by the polygon mirror 1002 scans the outer circumferential surface of the photosensitive drum 708 from right to left illustrated in FIG. 3.

The laser beam scanning the outer circumferential surface of the photosensitive drum 708 is corrected by an F-θ lens 1005 to scan the outer circumferential surface of the photosensitive drum 708 at a constant speed and radiated onto the outer circumferential surface of the photosensitive drum 708 via a reflecting mirror 1006.

A laser beam deflected by the polygon mirror 1002 enters a BD (Beam Detect) sensor 1004 as a light reception unit having a light detector for receiving the laser beam. According to the present exemplary embodiment, the BD sensor 1004 is disposed at such a position where, in a time period since the time when the BD sensor 1004 detects a laser beam till the time when it detects a laser beam again, a laser beam is detected by the BD sensor 1004 and then radiated onto the outer circumferential surface of the photosensitive drum 708. More specifically, as illustrated in FIG. 3, the BD sensor 1004 is disposed at an area outside the area indicated by an angle a within the area through which a laser beam reflected by the polygon mirror 1002 passes and more on the upstream side in the laser beam scanning direction.

The BD sensor 1004 generates a BD signal based on the detected laser beam and outputs the BD signal to the engine control unit 1009. Based on the input BD signal, the engine control unit 1009 controls the polygon motor so that the rotation period of the polygon mirror 1002 becomes a predetermined period. When the period of the BD signal reaches a period corresponding to the predetermined period, the engine control unit 1009 determines that the rotation period of the polygon mirror 1002 has reached the predetermined period.

The engine control unit 1009 outputs an image forming BD signal to the image control unit 1007 in response to the input BD signal. The image forming BD signal is in synchronization with the BD signal and corresponds to a signal which indicates one scanning period during which a laser beam scans the photosensitive drum 708.

The image control unit 1007 outputs the corrected image data to the laser control unit 1008 in response to the image forming BD signal input to the reception unit 1013. Specific control configurations of the engine control unit 1009 and the image control unit 1007 will be described below.

The laser control unit 1008 drives the laser beam source 1000 to blink based on the input image data to generate a laser beam for forming an image on the outer circumferential surface of the photosensitive drum 708. In this way, the laser control unit 1008 is controlled by the image control unit 1007 as an information processing apparatus. The generated laser beam is radiated onto the outer circumferential surface of the photosensitive drum 708.

A distance L from the position where a sheet sensor 726 detects the recording medium to the transfer position is longer than a distance x from the laser beam radiation position on the outer circumferential surface of the photosensitive drum 708 to the transfer position in the rotational direction of the photosensitive drum 708. More specifically, the distance L is the sum of the distance x and the distance over which the recording medium is conveyed in the time period since the time when the sheet sensor 726 detects the leading edge of the recording medium till the time when a laser beam is emitted from the laser beam source 1000. In the time period since the time when the sheet sensor 726 detects the leading edge of the recording medium till the time when a laser beam is emitted from the laser beam source 1000, the image control unit 1007 corrects the image data and controls the laser control unit 1008.

This completes descriptions of the configuration of the laser scanner unit 707.

### Method for Identifying Surface of Polygon Mirror

According to the period of the input image forming BD signal, the image control unit 1007 outputs the corrected image data to the laser control unit 1008 sequentially from the image data on the most upstream side in the sub scanning direction. The laser control unit 1008 controls the laser beam source 1000 according to the input image data to form an image on the outer circumferential surface of the photosensitive drum 708. Although, in the present exemplary embodiment, the polygon mirror 1002 has four surfaces, the number of the surfaces of the polygon mirror 1002 is not limited thereto.

An image is formed on the recording medium by laser beams which are deflected by a plurality of the reflection surfaces of the polygon mirror 1002. More specifically, as illustrated in FIG. 2, the image corresponding to the image data on the most upstream side in the sub scanning direction is formed, for example, by the laser beam deflected by the first surface of the polygon mirror 1002. Likewise, the image corresponding to the image data on the second most upstream side in the sub scanning direction is formed by the laser beam deflected by the second surface different from the first surface of the polygon mirror 1002. In this way, the image formed on the recording medium is composed of images formed by laser beams reflected by different reflection surfaces out of a plurality of the reflection surfaces of the polygon mirror 1002.

When a polygon mirror having four reflection surfaces is used as a polygon mirror for laser beam deflection, the angle made by two adjoining reflection surfaces of the polygon mirror 1002 may not exactly be 90 degrees. More specifically, when a polygon mirror having four reflection surfaces is seen from the rotational axis direction, there is a possibility that the angle made by two adjoining sides may not be exactly 90 degrees (i.e., the shape of the polygon mirror seen from the rotational axis direction may not be a square). When a polygon mirror having n reflection surfaces (n is a positive integer) is used, the shape of the polygon mirror seen from the rotational axis direction may not exactly be a regular polygon having n sides.

When a polygon mirror having four reflection surfaces is used, if the angle made by two adjoining reflection surfaces of the polygon mirror is not exactly 90 degrees, the position and size of an image formed by a laser beam will be different between each reflection surface. As a result, a distortion occurs in the image formed on the outer circumferential surface of the photosensitive drum 708, and accordingly a distortion also occurs in the image formed on the recording medium.

According to the present exemplary embodiment, therefore, the image data is subjected to correction (for example, correction of the image drawing start position) based on correction amounts (correction data) corresponding to a plurality of the reflection surfaces of the polygon mirror 1002. In this case, a configuration for identifying a surface where a laser beam is to be deflected is needed. The following describes an example of a method for identifying a surface where a laser beam is to be deflected. According to the present exemplary embodiment, a surface identification unit 1010 included in the image control unit 1007 identifies the surface for deflecting (reflecting) the laser beam out of a plurality of the reflection surfaces of the polygon mirror 1002.

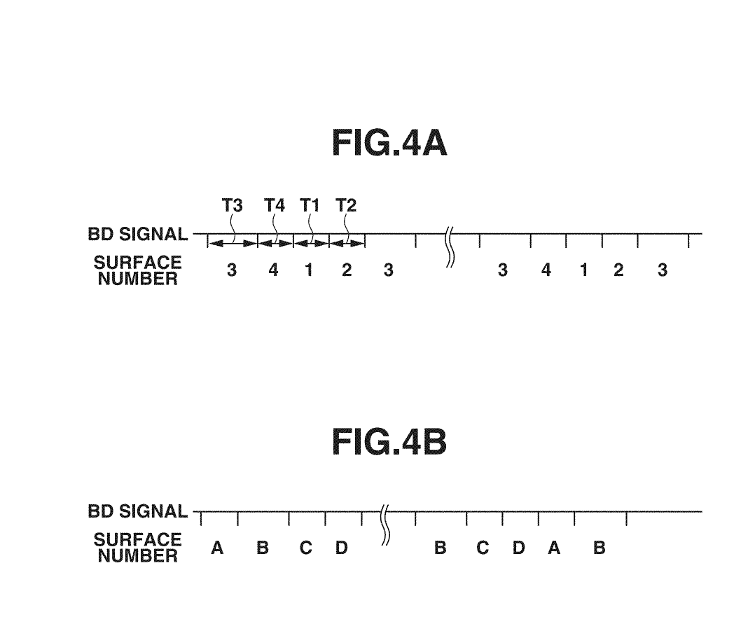

FIG. 4A illustrates an example of a relation between a BD signal generated when a laser beam scans the light receiving surface of the BD sensor 1004 and the surface (surface number) where the laser beam is to be deflected. As illustrated in FIG. 4A, the time period since the time when a pulse of the BD signal falls till the time when the BD signal falls for the first time after the BD signal falls (scanning period) is different between each surface of the polygon mirror 1002. The scanning period corresponds to the time period since the time when a laser beam scans the light receiving surface of the BD sensor 1004 till the time when the laser beam scans the light receiving surface again for the first time after the laser beam scans the light receiving surface.

Referring to FIG. 4A, a period T1 corresponds to the surface number 1, a period T2 corresponds to the surface number 2, a period T3 corresponds to the surface number 3, and a period T4 corresponds to the surface number 4. These time periods are stored in a memory 1010a provided in the surface identification unit 1010.

The surface identification unit 1010 identifies the surface (surface number) where a laser beam is to be deflected, by using the following method. More specifically, as illustrated in FIG. 4B, the surface identification unit 1010 sets the surface numbers A to D to four continuous scanning periods of the image forming BD signal input to the image control unit 1007. Then, the surface identification unit 1010 measures the scanning period a plurality of times (for example, 32 times) for each of the surface numbers A to D and calculates the average value of the measured periods for each of the surface numbers A to D.

Based on the calculated periods and the time periods T1 to T4 stored in the memory 1010a, the surface identification unit 1010 identifies which of the surface numbers 1 to 4 the surface numbers A to D respectively correspond to.

In this way, the surface identification unit 1010 identifies the number of a surface where a laser beam is to be deflected (the reflection surface to be used to scan the photosensitive drum 708 out of a plurality of the reflection surfaces of the polygon mirror 1002) based on the input image forming BD signal. In this way, the surface identification unit 1010 functions as an identification unit.

### Engine Control Unit

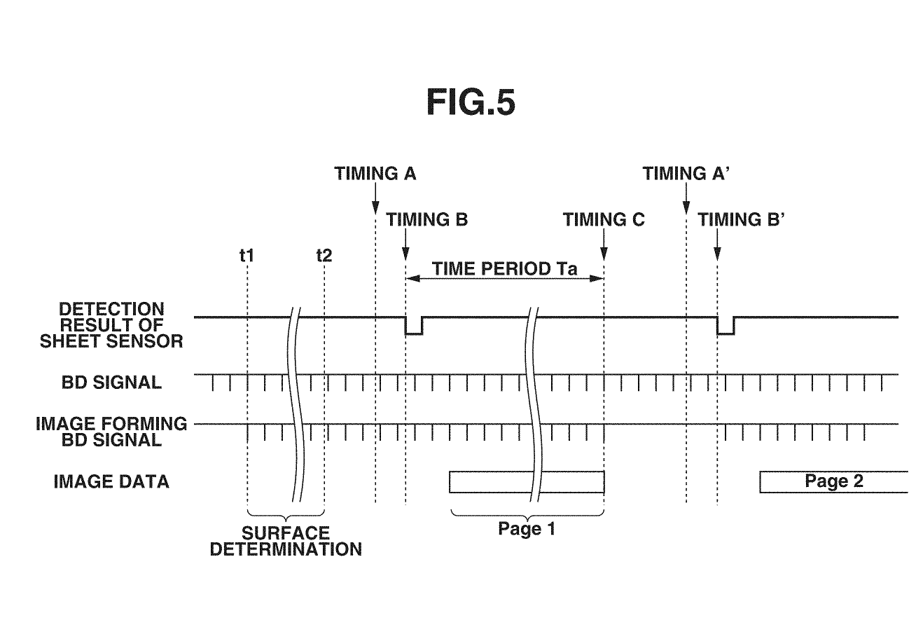

Control performed by the engine control unit 1009 according to the present exemplary embodiment will be described below with reference to FIGS. 3 and 5.

FIG. 5 is a timing chart illustrating various signals. When the rotation period of the polygon mirror 1002 reaches the predetermined period (time t1), the engine control unit 1009 starts outputting the image forming BD signal to the image control unit 1007 in response to (in synchronization with) the BD signal input from the BD sensor 1004.

The image control unit 1007 identifies the surface number by using the above-described method, based on the input image forming BD signal (surface determination). Upon completion of surface number identification, the image control unit 1007 outputs a signal indicating completion of surface number identification to the engine control unit 1009 via a communication interface (I/F) 1012 included in the image control unit 1007 (time t2).

Subsequently, the CPU 151 controls the engine control unit 1009 to perform printing (form an image on the recording medium) (timing A). As a result, the engine control unit 1009 starts driving the registration roller pair 723. As a result, the leading edge of a first recording medium is detected by the sheet sensor 726. The timing A is determined by the CPU 151 according to the processing time of a print job input to the image forming apparatus 100. More specifically, the timing A is not necessarily limited to the timing illustrated in FIG. 5.

As illustrated in FIG. 3, the engine control unit 1009 includes a counter 1009a for counting the number of pulses of the output image forming BD signal. When a signal indicating that the sheet sensor 726 has detected the leading edge of the first recording medium (timing B) is input, the engine control unit 1009 starts counting the number of pulses of the output image forming BD signal by using the counter 1009a. According to the present exemplary embodiment, the timing when the sheet sensor detection result illustrated in FIG. 5 becomes the low level corresponds to the timing when the sheet sensor 726 detects the leading edge of the recording medium.

When the number of counted pulses reaches the number of pulses corresponding to one page of the recording medium (time period Ta), the engine control unit 1009 stops outputting the image forming BD signal. According to the present exemplary embodiment, as illustrated in FIG. 5, when the engine control unit 1009 outputs the predetermined number of pulses (for example, three pulses) of the image forming BD signal since the time when the sheet sensor 726 has detected the leading edge of the recording medium, the image control unit 1007 starts outputting the image data. The number of pulses of the image forming BD signal in a time period since the time when the engine control unit 1009 outputs pulses of the image forming BD signal till the time when the image control unit 1007 starts outputting the image data is smaller than the number of pulses needed for surface identification.

When the sheet sensor 726 detects the leading edge of a second recording medium conveyed after the first recording medium, the engine control unit 1009 starts outputting the image forming BD signal.

In this way, the engine control unit 1009 does not output the image forming BD signal in a time period of a plurality of scanning periods, during a time period since the time when image formation based on the image data for one surface of the recording medium is completed till the time when image formation for the subsequent one surface of the recording medium following the image formation for the one surface of the recording medium is started. More specifically, the engine control unit 1009 functions as an output unit.

Although, in the present exemplary embodiment, the engine control unit 1009 starts outputting the image forming BD signal according to the timing when the sheet sensor 726 detects the leading edge of the recording medium, the configuration is not limited thereto. For example, the engine control unit 1009 may be configured to start outputting the image forming BD signal at a predetermined timing after a recording medium is fed. A predetermined timing is set so that the leading edge of the recording medium at the predetermined timing is at a predetermined position more on the upstream side of the transfer position.

In this way, the engine control unit 1009 starts outputting the image forming BD signal in response to the leading edge of the recording medium reaching the predetermined position which is more on the upstream side of the transfer position in the recording medium conveyance direction.

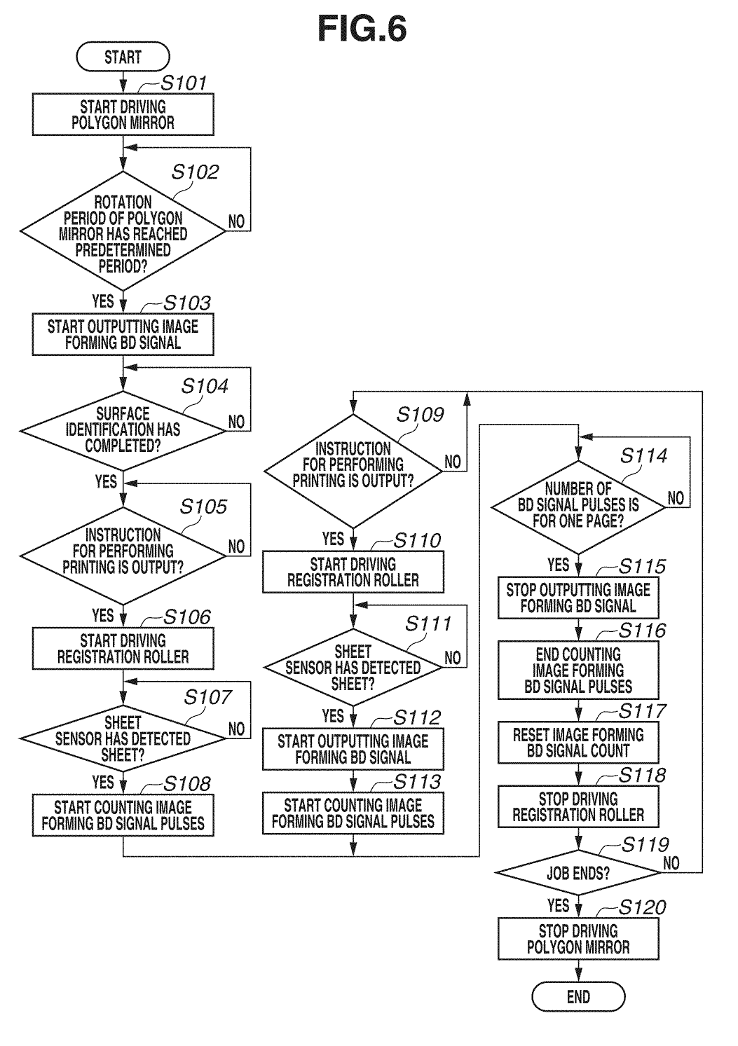

FIG. 6 is a flowchart illustrating control that is performed by the engine control unit 1009 according to the present exemplary embodiment. The processing of the flowchart illustrated in FIG. 6 is performed by the engine control unit 1009.

In step S101, when a print job is started, the engine control unit 1009 starts driving a motor (polygon motor) for rotatably driving the polygon mirror 1002.

In step S102, in a case where the rotation period of the polygon mirror 1002 has reached a predetermined period (YES in step S102), the processing proceeds to step S103. In step S103, the engine control unit 1009 starts outputting the image forming BD signal to the image control unit 1007 (time t1).

In step S104, in a case where a signal indicating completion of surface identification by the image control unit 1007 is input to the engine control unit 1009 via the communication I/F 1012 (time t2) (YES in step S104), the processing proceeds to step S105.

In step S105, in a case where an instruction for starting printing is output from the CPU 151 to the engine control unit 1009 (YES in step S105), the processing proceeds to step S106. In step S106, the engine control unit 1009 starts driving the registration roller pair 723. As a result, the conveyance of a recording medium is started.

In step S107, in a case where a signal indicating that the sheet sensor 726 has detected the leading edge of the recording medium is input to the engine control unit 1009 (YES in step S107), the processing proceeds to step S108. In step S108, the engine control unit 1009 starts counting the number of pulses of the output image forming BD signal. For example, the engine control unit 1009 counts the falling edge of pulses of the output image forming BD signal.

In step S114, in a case where the number of counted pulses has reached the number of pulses corresponding to one recording medium (time period Ta) (YES in step S114), the processing proceeds to step S115, In step S115, the engine control unit 1009 stops outputting the image forming BD signal.

In step S116, the engine control unit 1009 ends counting pulses of the output image forming BD signal. In step S117, the engine control unit 1009 resets the count.

In step S118, the engine control unit 1009 stops driving the registration roller pair 723.

In step S119, in a case where a print job does not end (NO in step S119), the processing returns to step S109.

The processing in steps S109 to S111 is similar to the processing in steps S105 to S107, and redundant descriptions thereof will be omitted.

In step S112, the engine control unit 1009 starts outputting the image forming BD signal to the image control unit 1007. In step S113, the engine control unit 1009 starts counting pulses of the output image forming BD signal. Then, the engine control unit 1009 performs processing in steps S114 to S118.

On the other hand, in step S119, in a case where a print job ends (YES in step S119), the processing proceeds to step S120. In step S120, the engine control unit 1009 stops driving the polygon mirror 1002 and ends the processing of this flowchart.

This completes descriptions of control performed by the engine control unit 1009.

### Image Control Unit

The control performed by the image control unit 1007 according to the present exemplary embodiment will be described below. According to the present exemplary embodiment, the image control unit 1007 identifies a reflection surface where a laser beam for scanning the light receiving surface of the BD sensor 1004 is to be deflected out of a plurality of the reflection surfaces of the polygon mirror 1002 in a time period since the time when image formation on the nth page (n is a positive integer) is completed till the time when image formation on the (n+1)th page is started. More specifically, in a time period during which the image forming BD signal is not input from the engine control unit 1009 to the image control unit 1007, the image control unit 1007 estimates a reflection surface where a laser beam for scanning the light receiving surface of the BD sensor 1004 is to be deflected out of a plurality of the reflection surfaces of the polygon mirror 1002. The configuration of the surface identification unit 1010 will be described below.

As illustrated in FIG. 3, the surface identification unit 1010 according to the present exemplary embodiment includes a counter 1010b for storing surface information indicating a reflection surface where a laser beam for scanning the light receiving surface of the BD sensor 1004 is to be deflected out of a plurality of the reflection surfaces. The surface identification unit 1010 further includes a timer A 1010c and a timer B 1010d as measurement units. The functions of the counter 1010b and the timers A 1010c and B 1010d will be described below.

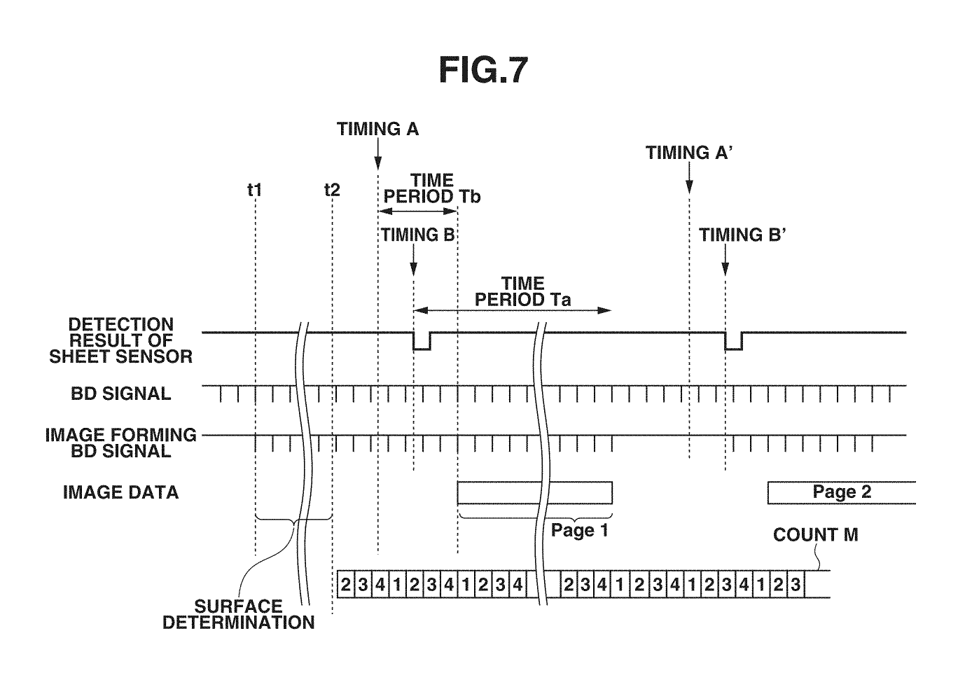

FIG. 7 is a time chart illustrating a relation between the count of the counter 1010b and the BD signal according to the present exemplary embodiment. The count of the counter 1010b corresponds to the surface information.

As illustrated in FIG. 7, at the time t2 when the surface identification unit 1010 completes surface number identification (estimation), the image control unit 1007 starts counting by using the counter 1010b. More specifically, upon completion of surface number identification, the image control unit 1007 sets the surface number indicated by the image forming BD signal input first after completion of surface number identification, as the initial value of the count M of the counter 1010b. After setting the initial value of the count M, the image control unit 1007 updates the count M, for example, each time a falling edge of the input image forming BD signal is detected. When the polygon mirror 1002 has n reflection surfaces (n is a positive integer), the count M is a positive integer that satisfies a condition 1≤M≤n. The count M is output to the image correction unit 1011 as the surface number.

As illustrated in FIG. 3, the image forming BD signal output from the engine control unit 1009 is input to the image correction unit 1011 as a correction unit. The image correction unit 1011 corrects and outputs the image data each time the image forming BD signal is input from the engine control unit 1009 to the image correction unit 1011. More specifically, each time the image forming BD signal is input from the engine control unit 1009 to the image correction unit 1011, the image correction unit 1011 corrects and outputs the image data sequentially from image data A on the most upstream side in the sub scanning direction out of a plurality of pieces of image data configuring the image for one page.

For example, when the surface number corresponding to the input pulse is ‘1’, the image correction unit 1011 performs correction corresponding to the surface number ‘1’ on the image data A and outputs the corrected image data A. More specifically, when the surface number corresponding to the input pulse is ‘1’, the image correction unit 1011 reads the correction data corresponding to the surface number ‘1’ from the memory 1011a. Then, the image correction unit 1011 corrects the image data A based on the read correction data and outputs the corrected image data A. Subsequently, when a pulse is input, the image correction unit 1011 corrects image data B on the most upstream side out of a plurality of pieces of image data on the downstream side of the image data A in the sub scanning direction based on the correction data corresponding to the surface number ‘2’ stored in the memory 1011a and outputs the corrected image data B. In this way, the correction data corresponding to each surface number is stored in the memory 1011a. More specifically, the memory 1011a stores a plurality of pieces of correction data respectively corresponding to the plurality of reflection surfaces in association with the surface information.

In this configuration, a laser beam corresponding to the image data corrected based on the correction data corresponding to the surface number ‘m’ (m is an integer from 1 to 4) is deflected by the reflection surface corresponding to the surface number ‘m’.

The image correction unit 1011 performs the above-described processing until correction of the image data for one surface of the recording medium is completed.

The image correction unit 1011 includes a counter 1011b for counting the number of areas for the output image data. When the count of the counter 1011b reaches the value corresponding to one recording medium (one page), the image correction unit 1011 stops outputting the image data.

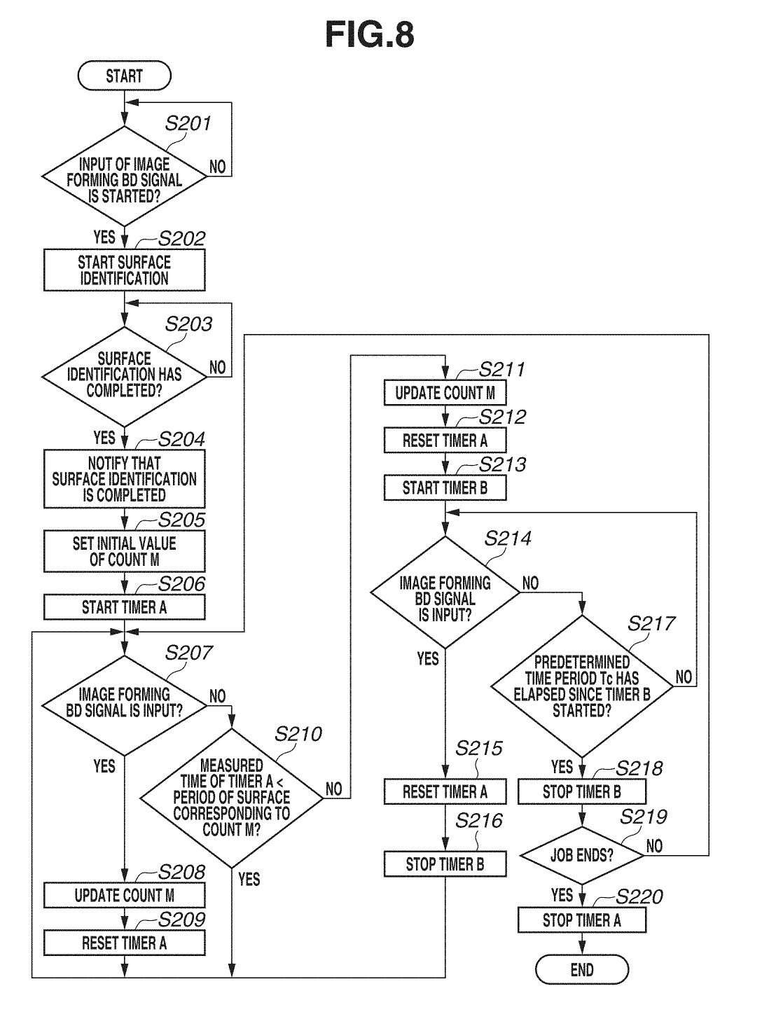

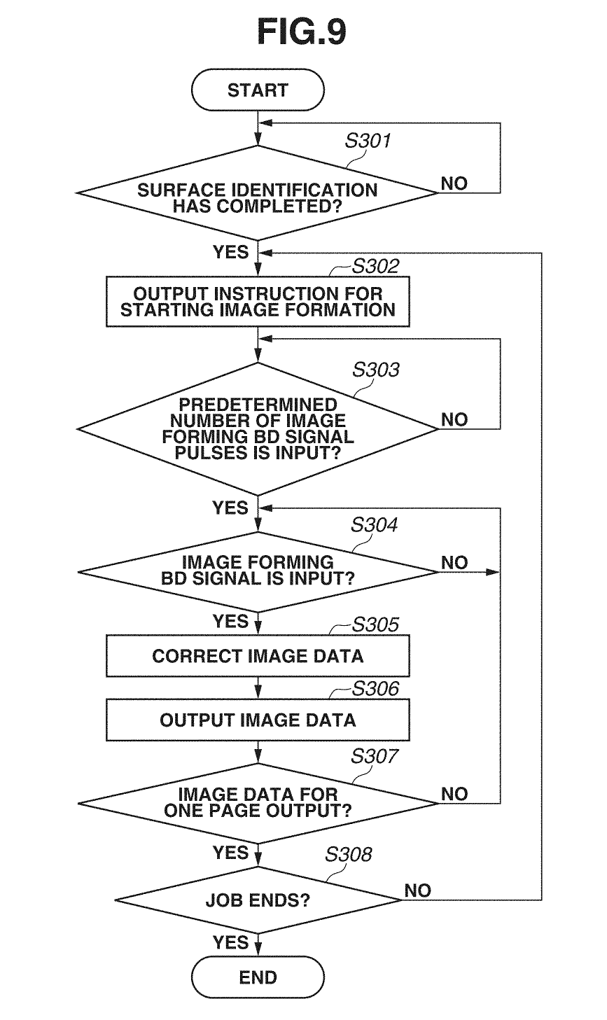

FIG. 8 is a flowchart illustrating a method performed by the image control unit 1007 to estimate (determine) which surface of the polygon mirror 1002 is indicated by the BD signal input to the engine control unit 1009. The processing of the flowchart illustrated in FIG. 9 is performed by the image control unit 1007. In the following descriptions, the surface number output from the surface identification unit 1010 to the image correction unit 1011 is updated each time the count M is updated.

As described above with reference to FIG. 6, when a print job is started and the rotation period of the polygon mirror 1002 reaches the predetermined period, the image forming BD signal is input to the image control unit 1007.

In step S201, in a case where the image control unit 1007 starts inputting the image forming BD signal (YES in step S201), the processing proceeds to step S202. In step S202, the image control unit 1007 (CPU 151) controls the surface identification unit 1010 to start surface identification. As a result, the surface identification unit 1010 starts surface identification.

In step S203, in a case where surface identification has completed (YES in step S203), the processing proceeds to step S204, In step S204, the image control unit 1007 notifies the engine control unit 1009 of completion of surface identification via the communication I/F 1012.

In step S205, the image control unit 1007 sets the surface number indicated by the image forming BD signal input first after completion of surface number identification, as the initial value of the count M of the counter 1010b.

In step S206, the image control unit 1007 starts time measurement using the timer A 1010c.

In step S207, in a case where the image forming BD signal is input to the image control unit 1007 (YES in step S207), the processing proceeds to step S208. In step S208, the surface identification unit 1010 updates the count M of the counter 1010b.

In step S209, the image control unit 1007 resets the measured time of the tinier A 1010c. Then, the processing returns to step S207.

On the other hand, in step S2007, in a case where the image forming BD signal is not input to the image control unit 1007 (NO in step S207), the processing proceeds to step S210.

In step S210, in a case where the measured time of the timer A 1010c is smaller than the period of the surface corresponding to the count M (YES in step S210), the processing returns to step S207. As described above, the period of the surface corresponding to the count M (surface number) is stored in the memory 1010a.

On the other hand, in step S210, in a case where the measured time of the timer A 1010c is longer than the period of the surface corresponding to the count M (NO in step S210), the processing proceeds to step S211. In step S211, the image control unit 1007 updates the count M of the counter 1010b.

In step S212, the image control unit 1007 resets the measured time of the timer A 1010c. In step S213, the image control unit 1007 starts time measurement using the timer B 1010d.

In step S214, in a case where the image forming BD signal is input to the image control unit 1007 (YES in step S214), the processing proceeds to step S215. In step S215, the image control unit 1007 resets the measured time of the timer A 1010c. In step S216, the image control unit 1007 stops time measurement using the timer B 1010d. Then, the processing returns to step S207.

On the other hand, in step S214, in a case where the image forming BD signal is not input to the image control unit 1007 (NO in step S214), the processing proceeds to step S217.

In step S217, in a case where a predetermined time period Tc has not elapsed since time measurement with the tinier B 1010d has started (NO in step S217), the processing returns to step S214.

On the other hand, in step S217, in a case where the predetermined time period Tc has elapsed since time measurement with the timer B 1010d has started (YES in step S217), the processing proceeds to step S218. In step S218, the image control unit 1007 stops time measurement using the timer B 1010d.

The predetermined time period Tc is set to a time period shorter than the period of the surface corresponding to the count M. Although, in the present exemplary embodiment, the predetermined time period Tc is set to, for example, a half of the period of the surface corresponding to the count M, the configuration is not limited thereto.

In step S219, in a case where a print job does not end (NO in step S219), the processing returns to step S207.

On the other hand, in step S219, in a case where the print job ends (YES in step S219), the image control unit 1007 stops time measurement by using the timer A 1010c and ends the processing of this flowchart.

FIG. 9 is a flowchart illustrating a method in which the image data is corrected and a method in which the corrected image data is output to the engine control unit 1009. The processing of the flowchart illustrated in FIG. 9 is performed by the CPU 151. In a time period during which the processing procedure of the flowchart illustrated in FIG. 9 is performed, the image control unit 1007 (image correction unit 1011) keeps counting the number of pieces of the output image data.

In step S301, in a case where the surface identification unit 1010 has completed surface identification (YES in step S301), the processing proceeds to step S302. In step S302, the CPU 151 outputs an instruction for starting image formation on a recording medium to the engine control unit 1009. As a result, the engine control unit 1009 starts driving the registration roller pair 723.

In step S303, in a case where a predetermined number of image forming BD signals (two image forming BD signals according to the present exemplary embodiment) is input, i.e., when a falling edge of the image forming BD signal is detected a predetermined number of times) (YES in step S303), the processing proceeds to step S304.

In step S304, in a case where the following image forming BD signal (third image forming BD signal according to the present exemplary embodiment) is input to the image control unit 1007 (YES in step S304), the processing proceeds to in step S305. In step S305, the CPU 151 controls the image correction unit 1011 to correct the image data based on the surface number indicated by the count M. As a result, the image correction unit 1011 corrects the image data based on the surface number indicated by the count M.

In step S306, the CPU 151 controls the image correction unit 1011 to output the image data corrected in step S305 to the laser control unit 1008 in synchronization with the image forming BD signal. As a result, the corrected image data is output to the laser control unit 1008 in synchronization with the image forming BD signal.

The image control unit 1007 repeats the processing in steps S304 to S306 until the image data for one surface (one page) of the recording medium is output.

Subsequently, the CPU 151 repeats the above-described processing until the print job ends.

As described above, according to the present exemplary embodiment, when the engine control unit 1009 has output the image forming BD signal the number of times for one page, the engine control unit 1009 stops outputting the image forming BD signal. Then, when the sheet sensor 726 detects a recording medium, the engine control unit 1009 starts outputting the image forming BD signal again. More specifically, the engine control unit 1009 does not output the image forming BD signal to the image control unit 1007 in a time period since the time when drawing on the nth page is completed till the time when drawing on the (n+1)th page is started. As a result, image formation is started in response to the input image forming BD signal, whereby it becomes possible to remove the signal line for transmitting a signal for determining the image formation start timing from the engine control unit 1009 to the image control unit 1007.

According to the present exemplary embodiment, the image control unit 1007 performs surface identification using the methods illustrated in FIGS. 4A and 4B in a first period since the time when a print job is started till the time when the image control unit 1007 starts outputting the image data corresponding to the image to be formed on the first surface of the recording medium. In a time period during which the image forming BD signal is not input from the engine control unit 1009 to the image control unit 1007, the image control unit 1007 estimates (identifies) a reflection surface where a laser beam for scanning the light receiving surface of the BD sensor 1004 is to be deflected. More specifically, the surface identification unit 1010 identifies the surface indicated by the BD signal input to the engine control unit 1009, by updating the count NI based on the timer A 1010c in a time period during which the image forming BD signal is not input to the image control unit 1007. As a result, when outputting the image forming BD signal to the image control unit 1007 is resumed, the image control unit 1007 is able to correct and output the image data without performing the surface identification processing illustrated in FIGS. 4A and 4B. The result makes it possible to prevent the productivity of the image forming apparatus 100 from being degraded.

Although, in the present exemplary embodiment, the surface identification unit 1010 updates the count M when the measurement result of the timer A 1010c exceeds the time period indicating the scanning period corresponding to the count M in a time period during which the image forming BD signal is not input, the configuration is not limited thereto. For example, the surface identification unit 1010 may update the count M based on the number of scanning periods in a time period during which the image forming BD signal is not input. More specifically, the surface identification unit 1010 may calculate the number of scanning periods corresponding to the time period during which the image forming BD signal is not input and update the count M based on the calculation result. More specifically, for example, when the time period during which the image forming BD signal is not input corresponds to three scanning periods, the surface identification unit 1010 updates the count M three times.

Although, in the present exemplary embodiment, the engine control unit 1009 stops outputting the image forming BD signal at the timing C (see FIG. 5) when pulses for one recording medium have been output, the configuration is not limited thereto. For example, the engine control unit 1009 may stop outputting the image forming BD signal at a timing after the timing C and before the timing A′ at which an instruction for starting printing on the next page is output. More specifically, the engine control unit 1009 may stop outputting the image forming BD signal at a predetermined timing after the timing C and before the timing A′.

Although, in the present exemplary embodiment, the engine control unit 1009 stops outputting the image forming BD signal when the number of counted pulses reaches the pulse count corresponding to one recording medium (time period Ta), the configuration is not limited thereto. For example, the engine control unit 1009 may be configured to stop outputting the image forming BD signal when the image data is no longer output from the image control unit 1007.

For components of the image forming apparatus according to a second exemplary embodiment similar to those according to the first exemplary embodiment, redundant descriptions will be omitted.

According to the first exemplary embodiment, the image control unit 1007 updates the count M based on the input image forming BD signal in a time period during which the image forming BD signal is input and updates the count M based on a timer in a time period during which the image forming BD signal is not input. According to the present exemplary embodiment, after performing surface identification using the method illustrated in FIGS. 4A and 4B, the image control unit 1007 updates the count M based on a timer. More specifically, the image control unit 1007 updates the count M based on a timer both in a time period during which the image forming BD signal is input and in a time period during which the image forming BD signal is not input.

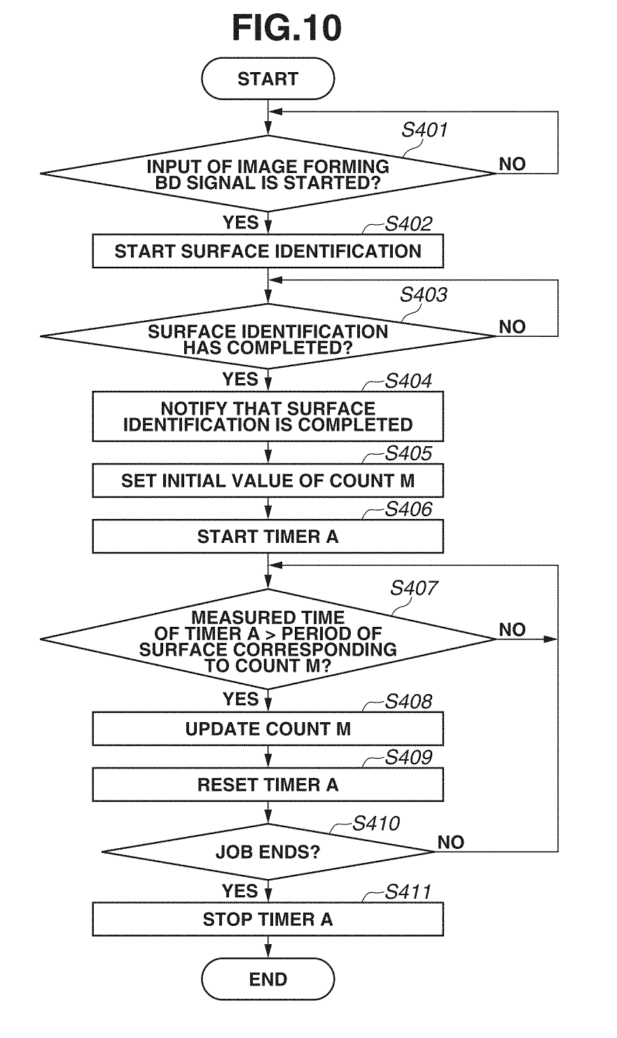

FIG. 10 is a flowchart illustrating a method performed by the image control unit 1007 to estimate a surface according to the present exemplary embodiment. The processing of the flowchart illustrated in FIG. 10 is performed by the image control unit 1007. In the following descriptions, the surface number output from the surface identification unit 1010 to the image correction unit 1011 is updated each time the count M is updated.

The processing in steps S401 to S406 is similar to the processing in steps S201 to S206 illustrated in FIG. 8 and redundant descriptions thereof will be omitted.

In step S407, in a case where the measured time of the timer A 1010c exceeds the period of the surface corresponding to the count NI (YES in step S407), the processing proceeds to step S408. In step S408, the image control unit 1007 updates the count M of the counter 1010b.

In step S409, the image control unit 1007 resets the measured time of the timer A 1010c. Then, the processing proceeds to step S410.

In step S410, in a case where a print job does not end (NO in step S410), the processing returns to step S407.

On the other hand, in step S410, in a case where the print job ends (YES in step S410), the processing proceeds to step S411. In step S411, the image control unit 1007 stops the tinier of the timer A 1010c and ends the processing of this flowchart.

As described above, according to the present exemplary embodiment, after performing surface identification using the method illustrated in FIGS. 4A and 4B, the image control unit 1007 updates the count M based on a timer. More specifically, the image control unit 1007 updates the count M based on a timer both in a time period during which the image forming BD signal is input and in a time period during which the image forming BD signal is not input. As a result, both in a time period during which the image forming BD signal is input and in a time period during which the image forming BD signal is not input, the image control unit 1007 is able to determine the surface indicated by the BD signal input to the engine control unit 1009. In addition, when outputting the image forming BD signal to the image control unit 1007 is resumed, the image control unit 1007 is able to correct and output the image data without performing the surface identification processing illustrated in FIGS. 4A and 4B. The result makes it possible to prevent the productivity of the image forming apparatus 100 from being degraded.

For components of the image forming apparatus according to a third exemplary embodiment similar to those according to the first exemplary embodiment, redundant descriptions will be omitted.

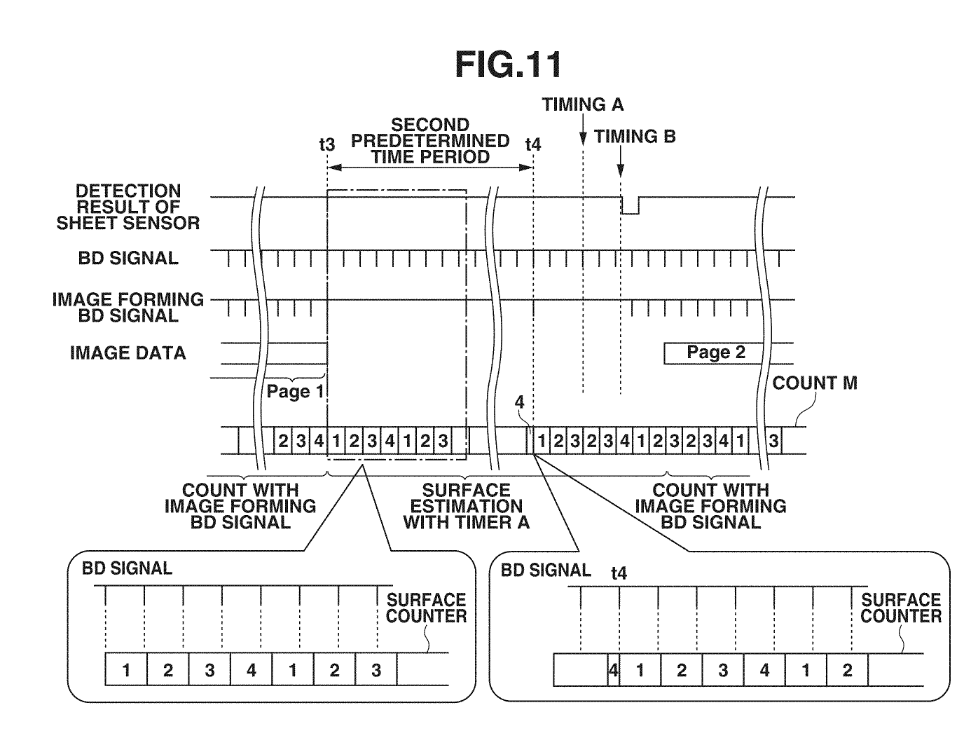

FIG. 11 is a time chart illustrating a relation between the count of the counter 1010b and the BD signal according to the present exemplary embodiment.

When the surface indicated by the BD signal input to the engine control unit 1009 is determined based on the timer A 1010c, the following issue may arise. More specifically, as illustrated in FIG. 11, the timing when the surface number is updated based on the timer A 1010c may lag behind the timing when the BD signal is input to the engine control unit 1009. The time difference between the timing when the surface number is updated based on the timer A 1010c and the timing when the BD signal is input to the engine control unit 1009 will increase every time the surface number is updated.

The larger number of print objects included in a print job input to the image forming apparatus 100 may cause a longer time period since the time when printing on the nth page is completed till the time when printing on the (n+1)th page is started. More specifically, the larger number of print objects included in a print job input to the image forming apparatus 100 may cause a longer time period during which the image forming BD signal is not input from the engine control unit 1009 to the image control unit 1007. Therefore, the larger number of print objects included in a print job input to the image forming apparatus 100 may cause the larger number of times the surface number is updated based on the timer A 1010c. Consequently, a time difference becomes large between the timing when the surface number is updated based on the timer A 1010c and the timing when the BD signal is input to the engine control unit 1009. As a result, the surface number to be used by the image correction unit 1011 to correct image data may become different from the surface number of the polygon mirror 1002 where a laser beam corresponding to the corrected image data is to be reflected. As a result, the image formed on the recording medium may be distorted. The relation between the count M and the BD signal illustrated in FIG. 11 is an example according to the present exemplary embodiment. For example, the increase in difference between the timing when the surface number is updated based on the timer A 1010c and the timing when the BD signal is input to the engine control unit 1009 is not necessarily limited to the amount illustrated in FIG. 11.

According to the present exemplary embodiment, the following configuration prevents the surface number to be used by the image correction unit 1011 to correct the image data from becoming different from the surface number of the polygon mirror 1002 where a laser beam corresponding to the corrected image data is to be reflected.

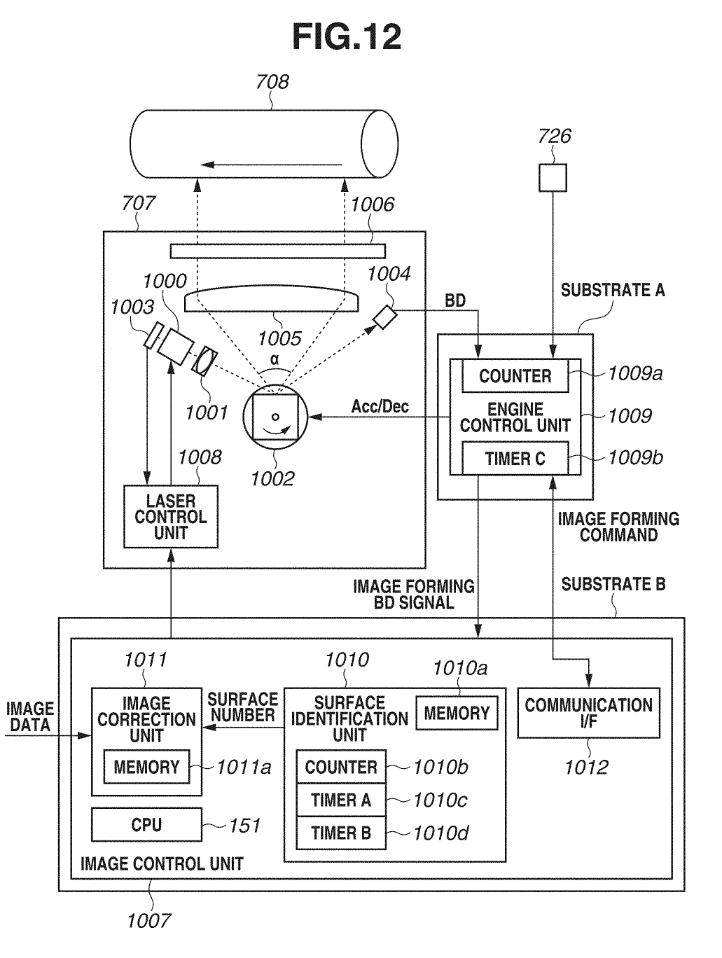

FIG. 12 is a block diagram illustrating a configuration of the laser scanner 707 according to the present exemplary embodiment. As illustrated in FIG. 12, the engine control unit 1009 includes a timer C 1009b. As illustrated in FIG. 11, when the engine control unit 1009 completes outputting the image forming BD signal the number of times for one page (time t3), the engine control unit 1009 starts time measurement using the tinier C 1009b. if an instruction for starting printing is not output from the CPU 151 even after a predetermined time period Td has elapsed since the timer C 1009b has started time measurement, the engine control unit 1009 outputs one pulse of the image forming BD signal. The predetermined time period Td is set to the following time period. More specifically, the predetermined time period Td is preset to a time period shorter than a time period Tx since the time when the surface number determination with the timer A 1010c is started till the time when the number of a surface where a laser beam corresponding to the corrected image data is to be deflected becomes different from the determined surface number. The time period Tx is predetermined, for example, on an experimental basis.

When the image forming BD signal is output once in this way, the count M is corrected at the time t4, as illustrated in FIG. 11. More specifically, at the time t4, the time difference between the timing when the surface number is updated based on the timer A 1010c and the timing when the BD signal is input to the engine control unit 1009 is reduced.

When the engine control unit 1009 outputs the image forming BD signal once at the time t4, the engine control unit 1009 resets the timer C 1009b. If an instruction for starting printing is not output from the CPU 151 even when the timer C 1009b reaches the predetermined time period Td after the time t4, the engine control unit 1009 outputs one pulse of the image forming BD signal again.

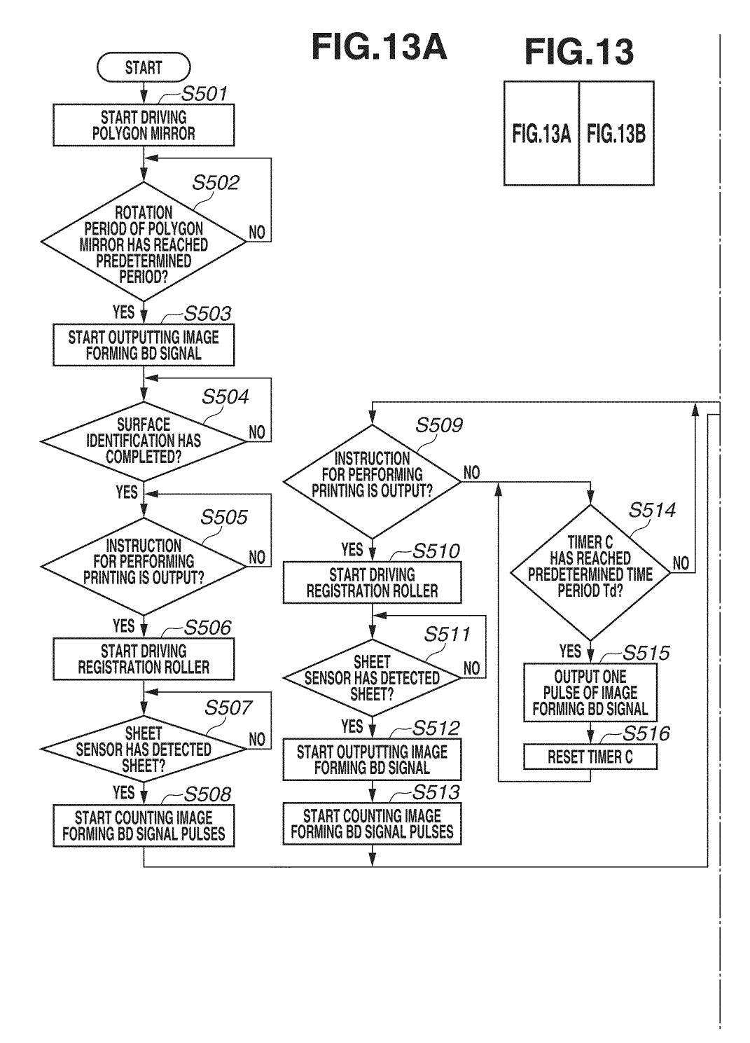

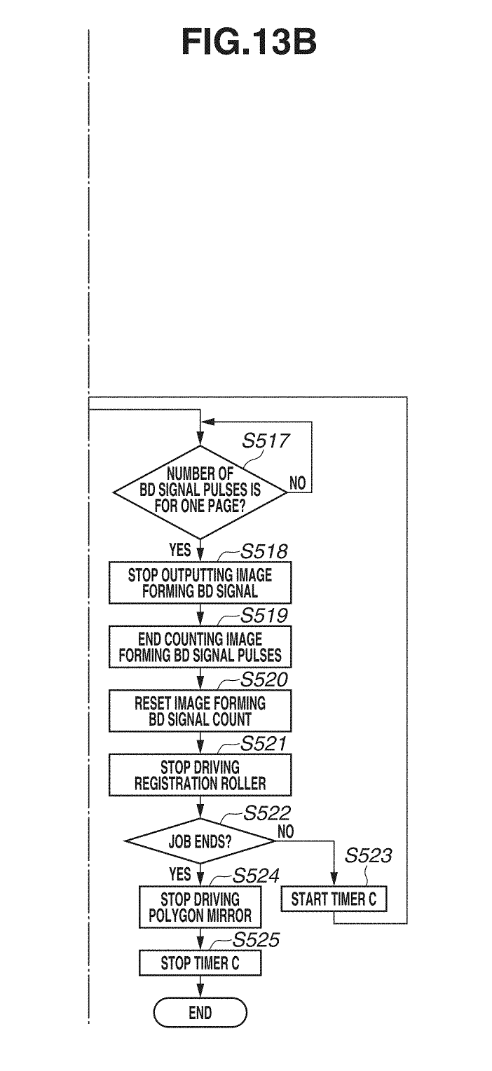

FIG. 13 is a diagram including the flowcharts of FIGS. 13A and 13B illustrating control performed by the engine control unit 1009 according to the present exemplary embodiment. The processing of this flowchart is performed by the engine control unit 1009.

The processing in steps S501 to S508 is similar to the processing in steps S101 to S108 illustrated in FIG. 6, and redundant descriptions thereof will be omitted.

The processing in steps S517 to S521 is similar to the processing from S114 to S118 illustrated in FIG. 6, and redundant descriptions thereof will be omitted.

In step S522, in a case where a print job does not end (NO in step S522), the processing proceeds to step S523. In step S523, the engine control unit 1009 starts the timer C 1009b. Then, the processing proceeds to step S509.

In step S509, in a case where an instruction for starting printing is output from the CPU 151 to the engine control unit 1009 (YES in step S509), the processing proceeds to step S510.

The processing from S510 to step S513 is similar to the processing in steps S110 to S113 illustrated in FIG. 6, and redundant descriptions thereof will be omitted.

On the other hand, in step S509, in a case where an instruction for starting printing is not input from the CPU 151 to the engine control unit 1009 (NO in step S509), the processing proceeds to step S514.

In step S514, in a case where the timer C 1009b has not reached the predetermined time period Td (NO in step S514), the processing returns to step S509.

On the other hand, in step S514, in a case where the timer C 1009b has reached the predetermined time period Td (YES in step S514), the processing proceeds to step S515. In step S515, the engine control unit 1009 outputs one pulse of the image forming BD signal. In step S516, the engine control unit 1009 resets the timer C 1009b. Then, the processing returns to step S514.

On the other hand, in step S522, in a case where a print job ends (YES in step S522), the processing proceeds to step S524. In step S524, the engine control unit 1009 stops driving the polygon mirror 1002.

In step S525, the engine control unit 1009 stops the timer C 1009b and ends the processing of this flowchart.

As described above, according to the present exemplary embodiment, if an instruction for starting printing is not output from the CPU 151 even after the predetermined time period Td has elapsed since the output of the image forming BD signal has been stopped, the engine control unit 1009 outputs one pulse of the image forming BD signal. Consequently, a time difference is reduced between the timing when the surface number is updated based on the timer A 1010c and the timing when the BD signal is input to the engine control unit 1009. As a result, it becomes possible to prevent the surface number to be used by the image correction unit 1011 to correct the image data from becoming different from the surface number of the polygon mirror 1002 where a laser beam corresponding to the corrected image data is to be reflected.

The number of pulses of the image forming BD signal output by the engine control unit 1009 is not limited to one and may be two or more (predetermined number). More specifically, the engine control unit 1009 may be configured to output the image forming BD signal for a predetermined time period so that at least one pulse of the image forming BD signal is output to the image control unit 1007.

According to the present exemplary embodiment, if an instruction for starting printing is not output from the CPU 151 even after the predetermined time period Td has elapsed since the timer C 1009b started, the engine control unit 1009 outputs image forming BD signal once, the configuration is not limited thereto. For example, when the timing when the count M is updated by the image control unit 1007 is notified to the engine control unit 1009, the engine control unit 1009 determines the time difference between the notified timing and the timing when the BD signal is output from the BD sensor 1004. The engine control unit 1009 may be configured to output the image forming BD signal once when the time difference becomes larger than a predetermined value. The predetermined value is preset to a value smaller than the time different in which the surface number of the polygon mirror 1002 where a laser beam corresponding to the corrected image data is reflected becomes different from the determined surface number.

For components of the image forming apparatus according to a fourth exemplary embodiment similar to those according to the first exemplary embodiment, redundant descriptions will be omitted.

In the first to the third exemplary embodiments, the image control unit 1007 estimates the surface number based on a tinier. According to the present exemplary embodiment, the image control unit 1007 estimates the surface number based on a signal (hereinafter referred to as a pseudo BD signal) in synchronization with the image forming BD signal.

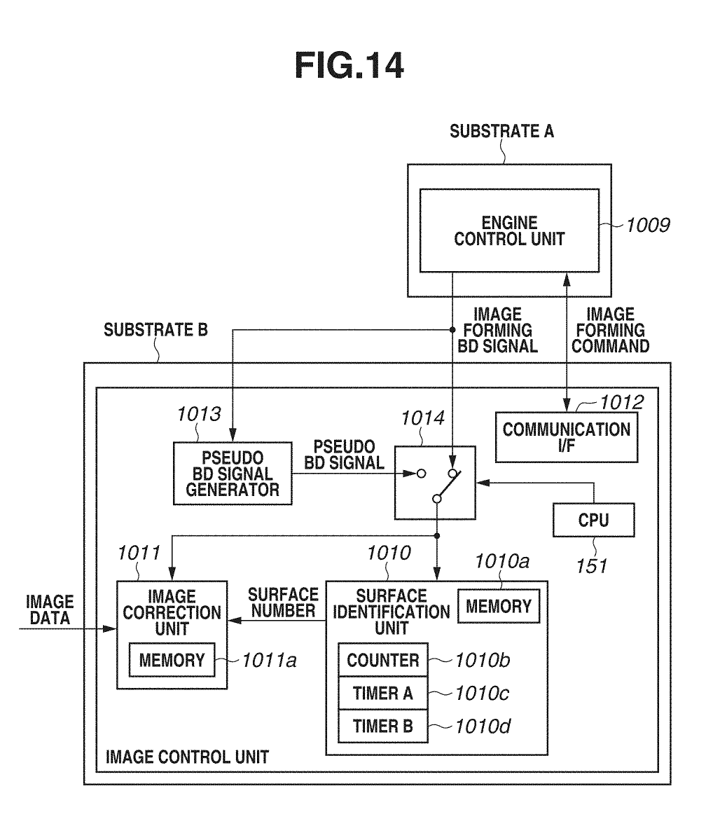

FIG. 14 is a block diagram illustrating a configuration of the image control unit 1007 according to the present exemplary embodiment. As illustrated in FIG. 14, the image control unit 1007 according to the present exemplary embodiment includes a pseudo BD signal generator 1013 for generating the pseudo BD signal. The image control unit 1007 further includes a switch 1014 for selecting whether the image forming BD signal is to be input to the surface identification unit 1010 or the pseudo BD signal is to be input to the surface identification unit 1010.

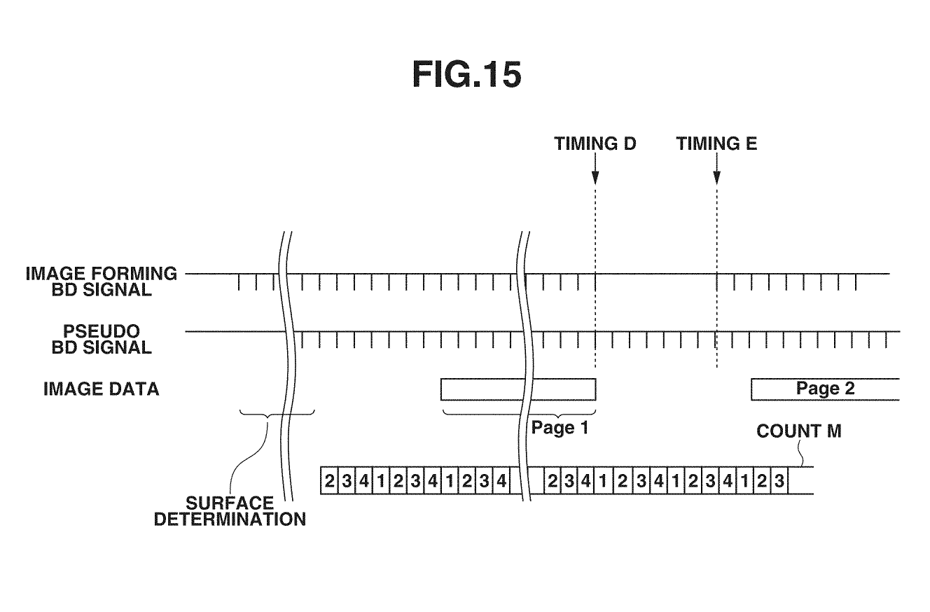

FIG. 15 is a time chart illustrating a relation between the image forming BD signal, the pseudo BD signal, and the count M. As illustrated in FIG. 15, based on the image forming BD signal output from the engine control unit 1009, the pseudo BD signal generator 1013 generates and outputs the pseudo BD signal as a signal in synchronization with the image forming BD signal. More specifically, the phase and period of the generated pseudo BD signal are in synchronization with the phase and period of the image forming BD signal. The pseudo BD signal corresponds to a second main scanning synchronization signal.

When the image data for one recording medium is output from the image control unit 1007 in a state where the image forming BD signal is being input to the image control unit 1007 (timing D), the CPU 151 changes the status of the switch 1014. As a result, the pseudo BD signal output from the pseudo BD signal generator 1013 is input to the surface identification unit 1010.

When the image forming BD signal is input to the image control unit 1007 in a state where the pseudo BD signal is input to the surface identification unit 1010 (timing E), the CPU 151 changes the state of the switch 1014. As a result, the image forming BD signal output from the engine control unit 1009 is input to the surface identification unit 1010.

The surface identification unit 1010 updates the count M at the timing when the input image forming BD signal or pseudo BD signal input changes (switches) from the first level (for example, the high level) to the second level (for example, the low level). Either one of the high and the low levels corresponds to the first level and the other level corresponds to the second level.

As described above, according to the present exemplary embodiment, the image control unit 1007 generates a pseudo BD signal and estimates the surface number (updates the count M) based on the pseudo BD signal. This allows the image control unit 1007 to determine the surface indicated by the BD signal input to the engine control unit 1009 even in a time period during which the image forming BD signal is not input. In addition, when the engine control unit 1009 resumes outputting the image forming BD signal to the image control unit 1007, the image control unit 1007 is able to correct and output the image data without performing the surface identification illustrated in FIGS. 4A and 4B, The result makes it possible to prevent the productivity of the image forming apparatus 100 from being degraded.

The configuration of the third exemplary embodiment, i.e., a configuration for reducing the time difference between the timing when the surface number is updated and the timing when the BD signal is input to the engine control unit 1009 may be applied to the present exemplary embodiment.

The image control unit 1007 may also be configured to determine a surface based on the pseudo BD signal also in a time period during which the image forming BD signal is input.

Although the first to the fourth exemplary embodiments have been described above centering on a monochrome electrophotographic copying machine, the configuration of the present exemplary embodiment is also applicable to a color electrophotographic copying machine.

According to the first to the fourth exemplary embodiments, the laser beam source 1000, the polygon mirror 1002, the photosensitive drum 708, the BD sensor 1004, and the engine control unit 1009 are included in an image forming unit.

Although, in the first to the fourth exemplary embodiments, the image control unit 1007 outputs the corrected image data to the laser control unit 1008, the configuration is not limited thereto. For example, the image control unit 1007 may be configured to output the corrected image data to the engine control unit 1009, and the engine control unit 1009 may be configured to output the image data to the laser control unit 1008. More specifically, it is desirable that the image control unit 1007 is configured to output the corrected image data to the image forming unit.

Although, in the first to the fourth exemplary embodiments, the sheet sensor 726 is disposed on the upstream side of the transfer position and on the downstream side of the registration roller pair 723, the configuration is not limited thereto. For example, the sheet sensor 726 may be disposed on the upstream side of the registration roller pair 723, and the engine control unit 1009 may output the image forming BD signal by using the method according to the present exemplary embodiment based on the detection result of the sheet sensor 726.

Although, in the first to the fourth exemplary embodiments, as described above with reference to FIGS. 4A, 4B, and 5, the surface number is identified based on the period of the BD signal, a method for identifying the surface number is not limited thereto. For example, the surface number may be identified based on a signal (for example, an encoder signal and an FG signal) indicating the rotation period of a motor for rotatably driving the polygon mirror 1002.

According to various embodiments of the present disclosure, it is possible to prevent the productivity of the image forming apparatus 100 from being degraded.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-183514, filed Sep. 25, 2017, which is hereby incorporated by reference herein in its entirety.

What is claimed is:

1. An information processing apparatus connected to an image forming apparatus including an image forming unit, the image forming unit comprising:
a first receptor configured to receive image data;
a light source configured to output light based on the image data received by the first receptor;
a photosensitive member;
a rotary polygon mirror having a plurality of reflection surfaces, configured to rotate to deflect the light output from the light source by using a plurality of the reflection surfaces to scan the photosensitive member;
a light receptor configured to receive the light deflected by the rotary polygon mirror; and
a first output unit configured to output a predetermined signal upon reception of the light by the light receptor in a time period during which the light based on the image data input to the first receptor is output from the light source, stop outputting the predetermined signal after the image data for one surface of a recording medium is output, and resume outputting the predetermined signal according to the timing when image formation for one surface of a subsequent recording medium following image formation for the one surface of the recording medium is started, the predetermined signal indicating a time interval since the time when the light receptor receives the light to be deflected by a first reflection surface out of a plurality of the reflection surfaces till the time when the light receptor receives the light to be deflected by a second reflection surface which is on the upstream side of the first reflection surface in the rotational direction of the rotary polygon mirror and adjacent to the first reflection surface, and
the information processing apparatus comprising:
a second receptor configured to receive the predetermined signal output from the first output unit;
a memory configured to store information about time intervals each corresponding to a different one of the plurality of reflection surfaces;
a determiner configured to, in a time period during which the predetermined signal is not input to the second receptor, determine a reflection surface by which the light for scanning the photosensitive member is to be deflected, based on the information stored in the memory;
a corrector configured to correct the image data based on the correction data corresponding to the reflection surface determined by the determiner; and
a second output unit configured to, in response to start of receiving the predetermined signal from the first output unit, start outputting image data to the image forming unit, the image data having been corrected by the corrector and being for the one surface of the subsequent recording medium.

2. The information processing apparatus according to claim 1, wherein, in a time period during which the predetermined signal is not input to the second receptor, the determiner updates surface information indicating the reflection surface when a time interval corresponding to the determined reflection surface out of the time intervals stored in the memory has elapsed since the reflection surface has been determined.

3. The information processing apparatus according to claim 1, further comprising a generator configured to generate a second predetermined signal synchronizing with a phase and period of the predetermined signal output from the first output unit,
wherein, in a time period during which the predetermined signal is not input to the second receptor, the determiner updates the surface information indicating the reflection surface when the second predetermined signal generated by the generator changes from a first level to a second level.

4. The information processing apparatus according to claim 1, wherein, in a time period during which the predetermined signal is input to the second receptor, the determiner updates the surface information indicating the reflection surface when a time interval corresponding to the determined reflection surface out of the time intervals stored in the memory has elapsed since the reflection surface has been determined.

5. The information processing apparatus according to claim 1, further comprising a generator configured to generate a second predetermined signal synchronizing with a phase and period of the predetermined signal output from the first output unit,
wherein, in a time period during which the predetermined signal is input to the second receptor, the determiner updates the surface information indicating the reflection surface when the second predetermined signal generated by the generator changes from a first level to a second level.

6. The information processing apparatus according to claim 1, wherein, in a time period during which the predetermined signal is input to the second receptor, the determiner updates the surface information indicating the reflection surface when the predetermined signal input to the second receptor changes from a first level to a second level.

7. The information processing apparatus according to claim 1, wherein, in a time period since the time when a print job is started till the time when the second output unit starts outputting the image data for a first surface in the print job, the determiner determines the reflection surface based on information about the time interval indicated by the predetermined signal input to the second receptor and the time intervals stored in the memory.

8. The information processing apparatus according to claim 1,
wherein a substrate provided for the information processing apparatus is different from a substrate provided for the first output unit; and
wherein the substrate provided for the information processing apparatus is connected, via a cable, with the substrate provided for the first output unit.

9. The information processing apparatus according to claim 1, wherein, the light output from the light source based on the image data corrected by the corrector by using first correction data is deflected by the reflection surface corresponding to the first correction data, and the light output from the light source based on the image data corrected by the corrector by using second correction data different from the first correction data is deflected by the reflection surface corresponding to the second correction data.

10. An image forming apparatus including a generator which generates image data and an image forming unit which forms an image on a recording medium based on the image data output from the generator, the image forming unit comprising:
a first receptor configured to receive image data;
a light source configured to output light based on the image data received by the first receptor;
a photosensitive member;
a rotary polygon mirror having a plurality of reflection surfaces, configured to rotate to deflect the light output from the light source by using a plurality of the reflection surfaces to scan the photosensitive member;
a light receptor configured to receive the light deflected by the rotary polygon mirror; and
a first output unit configured to output a predetermined signal upon reception of the light by the light receptor in a time period during which the light based on the image data input to the first receptor is output from the light source, stop outputting the predetermined signal after the image data for one surface of a recording medium is output, and resume outputting the predetermined signal at the timing when image formation for one surface of a subsequent recording medium following image formation for the one surface of the recording medium is started, the predetermined signal indicating a time interval since the time when the light receptor receives the light to be deflected by a first reflection surface out of a plurality of the reflection surfaces till the time when the light receptor receives the light to be deflected by a second reflection surface which is on the upstream side of the first reflection surface in the rotational direction of the rotary polygon mirror and adjacent to the first reflection surface, and
the generator comprising:
a second receptor configured to receive the predetermined signal output from the first output unit;
a memory configured to store information about time intervals each corresponding to a different one of the plurality of reflection surfaces;
a determiner configured to, in a time period during which the predetermined signal is not input to the second receptor, determine a reflection surface by which the light for scanning the photosensitive member is to be deflected, based on the information stored in the memory;
a corrector configured to correct the image data based on the correction data corresponding to the reflection surface determined by the determiner; and
a second output unit configured to, in response to start of receiving the predetermined signal from the first output unit, start outputting image data to the image forming unit, the image data having been corrected by the corrector and being for the one surface of the subsequent recording medium.

11. The image forming apparatus according to claim 10, wherein, in a time period during which the predetermined signal is not input to the second receptor, the determiner updates surface information indicating the reflection surface when a time interval corresponding to the determined reflection surface out of the time intervals stored in the memory has elapsed since the reflection surface has been determined.

12. The image forming apparatus according to claim 10, further comprising a second generator configured to generate a second predetermined signal synchronizing with a phase and period of the predetermined signal output from the first output unit,
wherein, in a time period during which the predetermined signal is not input to the second receptor, the determiner updates the surface information indicating the reflection surface when the second predetermined signal generated by the second generator changes from a first level to a second level.

13. The image forming apparatus according to claim 10, wherein, in a time period during which the predetermined signal is input to the second receptor, the determiner updates the surface information indicating the reflection surface when a time interval corresponding to the determined reflection surface out of the time intervals stored in the memory has elapsed since the reflection surface has been determined. 14, The image forming apparatus according to claim 10, further comprising a second generator configured to generate a second predetermined signal synchronizing with a phase and period of the predetermined signal output from the first output unit,
wherein, in a time period during which the predetermined signal is input to the second receptor, the determiner updates the surface information indicating the reflection surface when the second predetermined signal generated by the second generator changes from a first level to a second level.

15. The image forming apparatus according to claim 10, wherein, in a time period during which the predetermined signal is input to the second receptor, the determiner updates the surface information indicating the reflection surface when the predetermined signal input to the second receptor changes from a first level to a second level.

16. The image forming apparatus according to claim 10, wherein, in a time period since the time when a print job is started till the time when the second output unit starts outputting the image data for a first surface in the print job, the determiner determines the reflection surface based on information about the time interval indicated by the predetermined signal input to the second receptor and the time intervals stored in the memory.

17. The image forming apparatus according to claim 10, wherein the first output unit outputs a pulse of the predetermined signal the number of times corresponding to the image data for one surface of the recording medium and then stops outputting the predetermined signal.

18. The image forming apparatus according to claim 10,
wherein, in a time period during which the predetermined signal is not output, the first output unit outputs the predetermined signal to the second receptor for a predetermined time period when a time difference between the timing when the receptor receives the light and the timing when the determiner updates the surface information about the reflection surface exceeds a predetermined value, and
wherein the determiner updates the surface information about the reflection surface based on the predetermined signal output from the first output unit for the predetermined time period.

19. The image forming apparatus according to claim 10, wherein, the light output from the light source based on the image data corrected by the corrector by using first correction data is deflected by the reflection surface corresponding to the first correction data, and the light output from the light source based on the image data corrected by the corrector by using second correction data different from the first correction data is deflected by the reflection surface corresponding to the second correction data.
